(19) United States
(12) Patent Application Publication
(10) Pub. No.: US 2022/0240484 A1
(43) Pub. Date: Aug. 4, 2022

(54) Adjustable Animal Bowl Stand

(71) Applicant: Rigid Concepts LLC, Van Alstyne, TX (US)

(72) Inventors: Johnny DICKSON, Van Alstyne, TX (US); Catherine DICKSON, Van Alstyne, TX (US)

(21) Appl. No.: 17/164,035

(22) Filed: Feb. 1, 2021

(51) Int. Cl. A01K 5/01; F16M 11/04

(52) U.S. Cl. CPC A01K 5/0114; F16M 2200/027; F16M 11/041; F16M 11/046

(57) ABSTRACT

An adjustable animal bowl stand. The adjustable animal bowl stand may comprise the following base components: a horizontal base having a hole and a plurality of bores, a fastener extending through the horizontal base, a plurality of legs secured in the bores, a shaft connected to the horizontal base via the fastener, an adjustable clasp slidably connected around the shaft, and at least one bowl holder supported by the adjustable clasp and slidably coupled to the shaft. The horizontal base has a hole through the horizontal base and a plurality of bores located around the perimeter of the horizontal base. The plurality of legs fit in the plurality of bores. The fastener extends through the hole in the horizontal base and connects with the shaft. The adjustable clasp fits around the shaft. The at least one bowl holder is configured to support the at least one bowl.

### TECHNICAL FIELD

This disclosure relates to an adjustable animal bowl stand.

### BACKGROUND

Traditionally, animals ate and drank water from containers that were placed on the ground. However, it is more beneficial for animals to eat and drink from containers raised off the ground. For example, animals can better digest food when they eat off of a raised container. Additionally, elevated containers relieve older animals from the strain of eating and drinking from a container on the ground. Thus, it is desirable to have an adjustable animal bowl stand for animals of varying sizes.

### SUMMARY

This summary provides a discussion of aspects of certain embodiments of the disclosure. It is not intended to limit the disclosure or any of the claimed subject matter. The summary provides some aspects, but there are aspects and embodiments of the disclosure that are not discussed here.

The present disclosure relates to an adjustable animal bowl stand. The adjustable animal bowl stand may comprise the following base components: a horizontal base having a plurality of bores, a plurality of legs secured in the plurality of bores, a shaft attached to the horizontal base, an adjustable clasp slidably connected around the shaft, and at least one bowl holder supported by the adjustable clasp and slidably coupled to the shaft.

The horizontal base can have a hole through the horizontal base and a plurality of bores located around the perimeter of the horizontal base. A plurality of legs for stabilizing the adjustable animal stand can be attached in the plurality of bores located around the perimeter of the horizontal base. A fastener can extend through the hole in the horizontal base. The shaft has a bore in a first end that engages with the fastener, enabling the shaft to extend perpendicularly from the horizontal base. The adjustable clasp may comprise an enclosure that forms a perimeter around the adjustable clasp. The adjustable clasp may further comprise a bore configured to receive a fastener that secures the adjustable clasp to the shaft.

### BRIEF DESCRIPTION OF THE DRAWINGS

The novel features believed characteristic of the disclosure are outlined in the appended claims. The disclosure itself, however, as well as a preferred mode of use, further objectives, and advantages thereof, will be best understood by reference to the following detailed description of illustrative embodiments when read in conjunction with the accompanying drawings, wherein:

FIG. 1 is a perspective view of an adjustable animal bowl stand in accordance with at least one embodiment of the present disclosure;

FIG. 2 is a rear view of an adjustable animal bowl stand in accordance with at least one embodiment of the present disclosure;

FIG. 3 is a perspective view of an adjustable clasp for an adjustable animal bowl stand in accordance with at least one embodiment of the present disclosure;

FIG. 4 is a top view of an adjustable animal bowl stand in accordance with at least one embodiment of the present disclosure;

FIG. 5 is a top view of a bowl holder for an adjustable animal bowl stand in accordance with at least one embodiment of the present disclosure;

FIG. 6 is an assembled view of an adjustable animal bowl stand in accordance with at least one embodiment of the present disclosure;

FIG. 7 is a front perspective view of an adjustable animal bowl stand in accordance with at least one embodiment of the present disclosure;

FIG. 8 is a front view of an adjustable animal bowl stand in accordance with at least one embodiment of the present disclosure;

FIG. 9 is a rear view of an adjustable animal bowl stand in accordance with at least one embodiment of the present disclosure;

FIG. 10 is a right side view of an adjustable animal bowl stand in accordance with at least one embodiment of the present disclosure;

FIG. 11 is a left side view of an adjustable animal bowl stand in accordance with at least one embodiment of the present disclosure;

FIG. 12 is a top perspective view of an adjustable animal bowl stand in accordance with at least one embodiment of the present disclosure;

FIG. 13 is a bottom view of an adjustable animal bowl stand in accordance with at least one embodiment of the present disclosure;

FIG. 14 is a front perspective view of an adjustable animal bowl stand in accordance with at least one embodiment of the present disclosure;

FIG. 15 is a front perspective view of an adjustable animal bowl stand in accordance with at least one embodiment of the present disclosure;

FIG. 16 is a front view of an adjustable animal bowl stand in accordance with at least one embodiment of the present disclosure;

FIG. 17 is a rear view of an adjustable animal bowl stand in accordance with at least one embodiment of the present disclosure;

FIG. 18 is a right side view of an adjustable animal bowl stand in accordance with at least one embodiment of the present disclosure;

FIG. 19 is a left side view of an adjustable animal bowl stand in accordance with at least one embodiment of the present disclosure;

FIG. 20 is a top perspective view of an adjustable animal bowl stand in accordance with at least one embodiment of the present disclosure;

FIG. 21 is a bottom view of an adjustable animal bowl stand in accordance with at least one embodiment of the present disclosure; and

FIG. 22 is a front perspective view of an adjustable animal bowl stand in accordance with at least one embodiment of the present disclosure.

### DETAILED DESCRIPTION

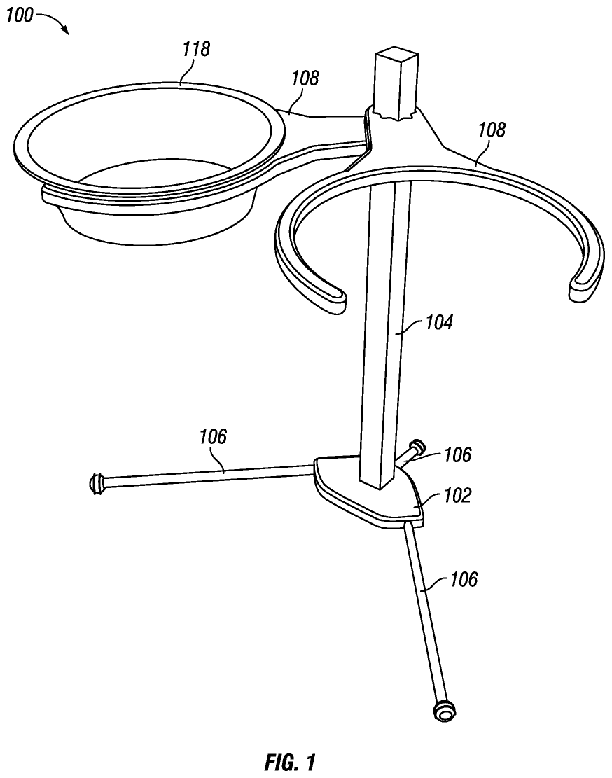

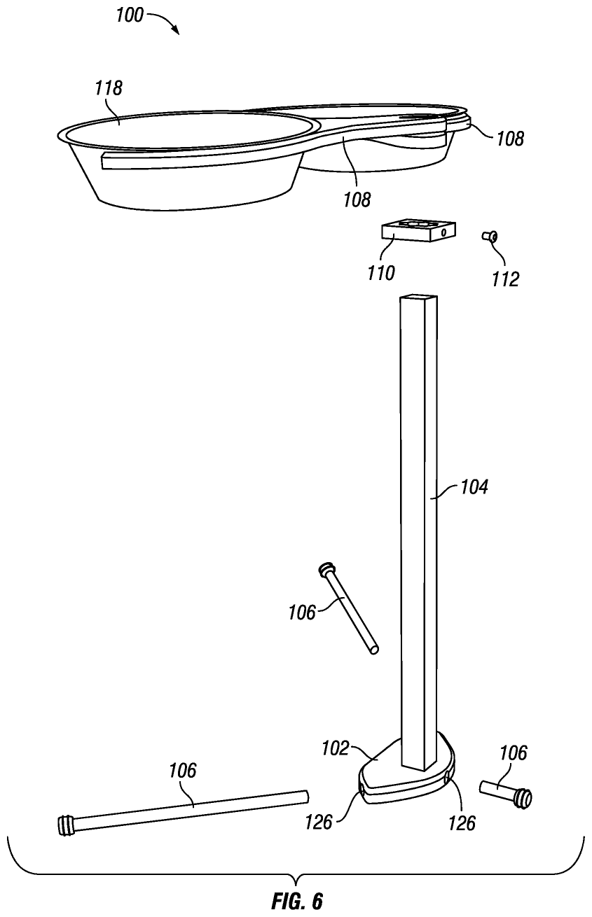

With reference to FIGS. 1, 2, and 6, the adjustable animal stand 100 for holding a bowl 118 comprises the following base components: a horizontal base 102 having a hole and a plurality of bores 126, a fastener extending through the bottom of the horizontal base 102, a plurality of legs 106 secured in the bores 126, a shaft 104 attached to the horizontal base via the fastener, an adjustable clasp 110 slidably connected around the shaft 104, and at least one bowl holder 108 supported by the adjustable clasp 110 and slidably coupled to the shaft 104.

The horizontal base 102 may have a hole (not shown) through the bottom of the horizontal base 102 and a plurality of bores 126 located around the perimeter of the horizontal base. As used herein, “plurality of bores” means one or more bores. The horizontal base 102 may have a hexagonal shape and three bores located on every other side of the hexagonal shape. Alternatively, the horizontal base 102 may have any other shape and at least two bores spaced around the perimeter of the horizontal base 102. The horizontal base 102 may be constructed out of stainless steel or any other durable material known in the art. The plurality of legs 106 for stabilizing the adjustable animal stand 100 fits in the plurality of bores 126 located around the perimeter of the horizontal base 102. As used herein, “plurality of legs” means one or more legs. The shape of the plurality of legs 106 may be any shape, such as but not limited to, cylindrical, triangular, square, pentagonal, etc. In one embodiment, the plurality of legs 106 includes a threaded portion on the proximal end of the plurality of legs 106, which are configured to screw into the plurality of bores 126 located around the perimeter of the horizontal base 102. Additionally, the plurality of legs 106 may include rubber feet affixed to the distal end of the plurality of legs 106. In an alternative embodiment, the plurality of legs 106 may be magnetically secured to the bores 126 in the horizontal base 102. The plurality of legs 106 may be configured to have a female connection extending from the distal end of the plurality of legs to a distance toward the midpoint. The female connection may be coated with any magnetic material known to a skilled artisan. The bores 120 in the horizontal base 102 may comprise a male connection that is sized and configured to fit inside the female connection. The male connection may be made of or coated with any magnetic material known to a skilled artisan. When the plurality of legs 106 are inserted into the bores 120 of the horizontal base 102, the female connections and their corresponding male connections couple together, which stabilize the adjustable animal stand 100.

In an alternative embodiment, the horizontal base 102 has a substantially larger area and does not comprise any legs 106. Substantially larger is defined as having an area at least 1.5 times larger. In an alternate embodiment, the horizontal base 102 comprises a magnetic bottom side that stabilizes the adjustable animal stand 100 to magnetic surfaces. Alternately, the horizontal base 102 comprises a housing having a magnet, that stabilizes the adjustable animal stand 100 to magnetic surfaces. In another embodiment, the horizontal base 102 comprises an adhesive material on the bottom side that secures the adjustable animal stand 100 to a surface. In another embodiment, the horizontal base 102 is configured with mounting features to attach the horizontal base 102 to a fixed surface. Non-limiting examples of mounting features may be holes, hooks, clasps, suction cups, and the like.

In some embodiments, the plurality of legs 106 may have a length ranging from about 2.5 cm (˜1 inch) to about 38 cm (˜15 inches). In one embodiment having three legs, two legs have a length between 12.5 cm (˜5 inches) and 38 cm (˜15 inches), and the third leg has a length between 2.5 cm (−1 inch) and about 12.5 cm (˜5 inches). The plurality of legs 106 may have a diameter between 0.95 cm (˜0.375 inches) and 1.3 cm (˜0.5 inches). The length of the plurality of legs 106 may depend on the positioning of the bowl holders 108 to keep the adjustable animal stand 100 from tipping over. In another embodiment having three legs, the angle between the first leg and the second leg is between 30 degrees and 90 degrees, and the third leg forms an angle greater than 90 degrees from both the first leg and the second leg. In another embodiment, the leg 106 may be modular and made up of multiple pieces. For example, the of legs 106 may have three modular pieces that may be assembled into a leg to attach to the horizontal base 102. The modular pieces may have a tapered shape with an end with a larger diameter and an end with a smaller diameter, wherein the ends with the smaller diameter slide into the ends with a larger diameter until the pieces are fully engaged. Fully engaged is defined as the smaller piece not being able further slide into the larger piece. In another embodiment, the plurality of legs may have a curved shape. The curved shape of the plurality of legs may be in the same plane as the horizontal base 102. Alternatively, the curved shape of the plurality of legs may be in a plane perpendicular to the horizontal base 102. In still another embodiment, the plurality of legs 106 may consist of a first leg, a second leg, a third leg, and a fourth leg. The four legs 106 may have the same length between 12.5 cm (˜5 inches) and 38 cm (˜15 inches). The two legs on a first latitudinal side may be angled, within the same plane as the base 102, between 45 degrees to 170 degrees from the base 102. Similarly, the two legs on a second latitudinal side may be angled, within the same plane as the base 102, between 45 degrees to 170 degrees from the base 102.

With continued reference to FIGS. 1, 2, and 6, the adjustable animal bowl stand comprises a fastener extending through the bottom of the horizontal base 102. The shaft 104 has a bore in the bottom of the first end that allows the fastener to engage the shaft on the second end, which enables the shaft to extend in a vertical direction from the horizontal base 102. The fastener may comprise a threaded portion that is configured to be screwed into the bore. Alternatively, the shaft 104 may be welded to the top of the horizontal base 102. In some embodiments, the shaft 104 may be square. In embodiments where the shaft 104 is square, the shaft 104 may have a height between 10 cm (˜4 inches) and 102 cm (˜40 inches); a length between 0.9 cm (˜⅜ inch) and 5 cm (˜2 inches); and a width between 0.9 cm (˜⅜ inch) and 5 cm (˜2 inches). In an alternative embodiment, the bottom of the horizontal shaft 102 comprises a housing that comprises a fastener configured to extend through the bottom of the horizontal base 102. The housing further comprises a protrusion from the wall of the housing. The protrusion is configured to engage with the fastener to prevent the fastener from rotating that could result in the shaft 104 detaching from the horizontal base 102. In an alternate embodiment, the shaft 104 may be comprised of multiple modular pieces, which may be easily assembled and disassembled. Additionally, the multiple modular pieces enable the height of the shaft 104 to be increased or decreased. In still another embodiment, the horizontal base 102 further comprises a vertical member that is attached to the horizontal base 102 via at least one fastener. The shaft 104 may comprise a bore through opposite sides near the proximal end of the shaft. The shaft 104 may be inserted into the vertical member and secured to the vertical member via a fastener through the bore. The vertical member enables the adjustable animal stand 100 to be quickly disassembled. Whatever the of configuration of the plurality of legs 106, the plurality of legs 106 may be attached to the horizontal base 102 in any manner as disclosed herein.

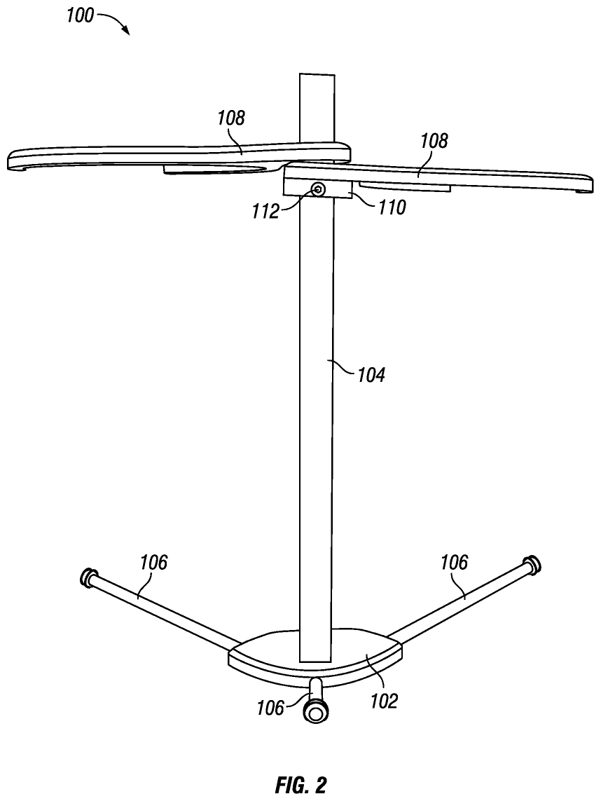

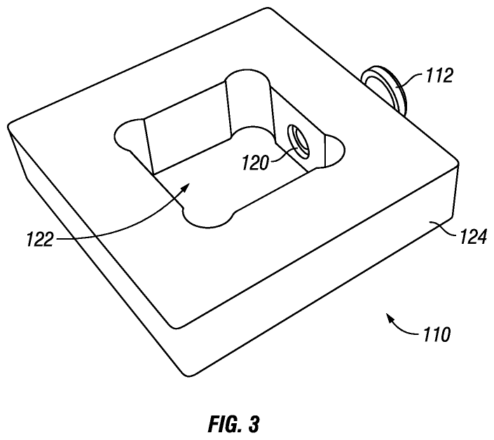

Referring to FIGS. 2 and 3, an adjustable clasp 110 is configured to connect slidably around the shaft 104. The adjustable clasp 110 may comprise a plurality of walls 124 that forms a perimeter around the adjustable clasp 110. As used herein, “plurality of walls” means one or more walls. The adjustable clasp 110 may further comprise a hole 122 through the adjustable clasp 110. The hole 122 is dimensioned to fit around the shaft 104. In one embodiment, the adjustable clasp 110 may further include a bore 120 extending through the enclosure to the hole 122. The adjustable clasp 110 may further include a fastener (alternatively referred to as a friction locking mechanism) 112 dimensioned to fit through the bore 120 and engage with the shaft 104. When the fastener 112 engages with the shaft 104, the adjustable clasp 110 is secured to the shaft 104. The adjustable clasp 110 may be configured to be adjustable in height along the length of the shaft 104.

In some embodiments, the fastener 112 comprises a threaded portion that is configured to screw through the bore 120 and engage with the square shaft 104. In an alternate embodiment, the shaft 104 comprises a plurality of protrusions along the length of the shaft 104. As used herein, “plurality of protrusions” means one or more protrusions. The adjustable clasp 110 is configured to slidably connect around the shaft 104 and rest on a protrusion. In one embodiment, the protrusions are spring-loaded inside of the shaft 104. The adjustable clasp 110 may be moved to another position along the shaft 104 by pressing a protrusion inwardly and sliding the adjustable clasp 110 over the depressed protrusion until the adjustable clasp engages another protrusion. In another embodiment, the protrusions are pegs that are inserted into holes along the length of the shaft 104 and engage port. The adjustable clasp 110 may be moved to another position along the shaft 104 by pulling a protrusion out of the port in the shaft and sliding the adjustable clasp 110 until the adjustable clasp 110 engages another protrusion. In another embodiment, the shaft 104 comprises a plurality of holes along the length of the shaft 104. As used herein, “plurality of holes” means one or more holes. The adjustable clasp 110 may be configured with a spring-loaded protrusion that is placed within a bore 120 extending through a wall 124. The spring-loaded protrusion extends into the hole 122 in a released state. The spring-loaded protrusion is configured to retract into the bore as it is pulled out of the hole 122. The spring-loaded protrusion is configured to extend into a hole in the shaft 104 when released.

In embodiments where the shaft is square, the adjustable animal bowl stand 110 comprises an adjustable square clasp 110 that is configured to connect slidably around the square shaft 104. The adjustable square clasp 110 comprises a square hole 122 through the adjustable square clasp 110, wherein the square hole 122 is configured to fit around the square shaft 104. The adjustable square clasp 110 further comprises a bore 120 extending through the perimeter of the adjustable square clasp 100 to the square hole 122. The adjustable square clasp 110 further comprises a fastener 112 dimensioned to fit through the bore 120 and engage with the square shaft 104. In some embodiments, the fastener 112 comprises a threaded portion that is configured to screw through the bore 120 and engage with the square shaft 104. When the fastener 112 engages with the square shaft 104, the adjustable square clasp 110 is secured in place to the square shaft 104. The adjustable square clasp 110 may have a length between 2.5 cm (˜1 inch) and 7.6 cm (˜3 inches); a width 2.5 cm (˜1 inch) and 7.6 cm (˜3 inches); and a height between 0.63 cm (˜0.25 inches) and 2.5 cm (˜1 inch).

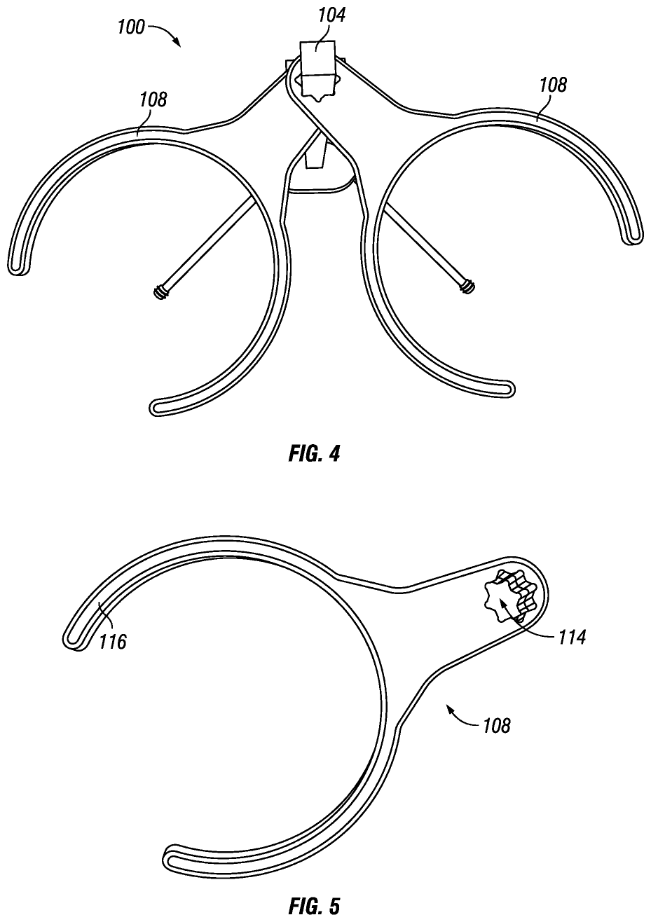

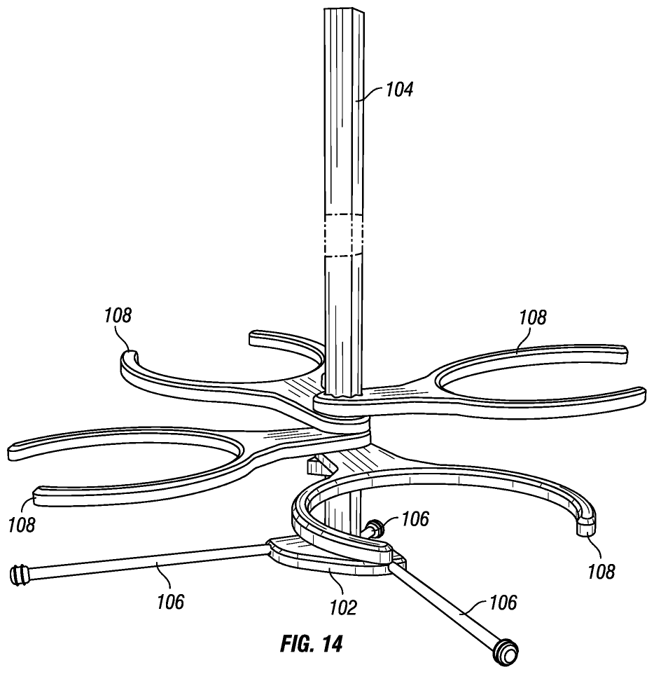

Referring to FIGS. 4 and 5, the adjustable animal bowl stand comprises at least one bowl holder 108 that is configured to slide onto the shaft 104 and rest on top of the adjustable clasp 110. As used herein, “at least one bowl holder” means one or more bowl holders 108. The at least one bowl holder 108 is configured to support the at least one bowl 118. The at least one bowl holder 108 comprises a hole 114 located at a proximal end of the at least one bowl holder 108. The hole 114 is configured to fit around the shaft 104. The at least one bowl holder 108 further comprises a rack 116 located at a distal end of the at least one bowl holder 108. In one embodiment, the shaft 104 is a square prism, and the at least one bowl holder comprises an octagonal hole 114 that enables the at least one bowl holder 108 to be adjusted to eight different positions around the shaft 104. Additionally, the shaft may be of any other shape (e.g., cylindrical, triangular, pentagonal, hexagonal, etc.). The bowl holders 108 may be adjusted to varying positions along the length of the shaft 104. For example, as shown in FIG. 14, the bowl holders 108 would be positioned closer to the base 102 to allow a smaller animal to reach the contents of the bowls 118. On the other hand, the bowl holders 108 would be positioned closer to the top of the shaft to allow a larger animal to reach the contents of the bowls 118. In another embodiment, the bowl holders 108 may be integrated with the adjustable clasp 110. The integrated adjustable clasp may be configured with similarly to other adjustable clasps 110 described herein.

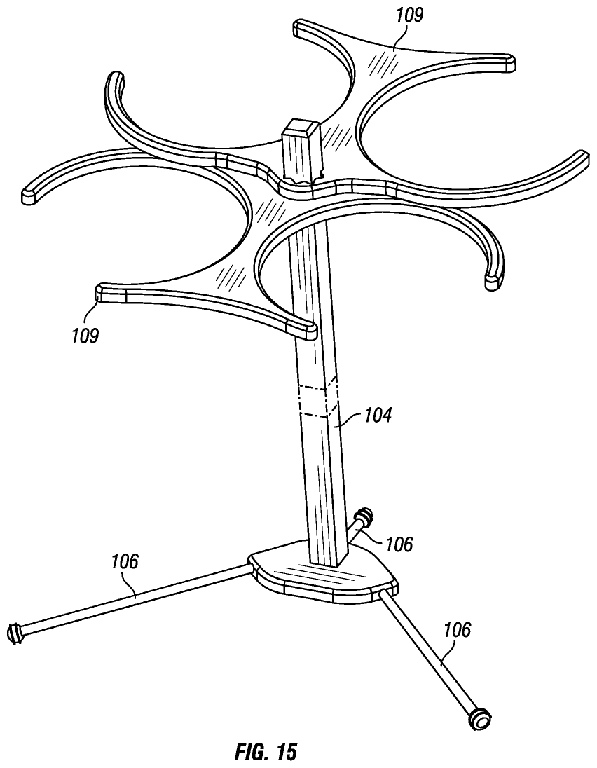

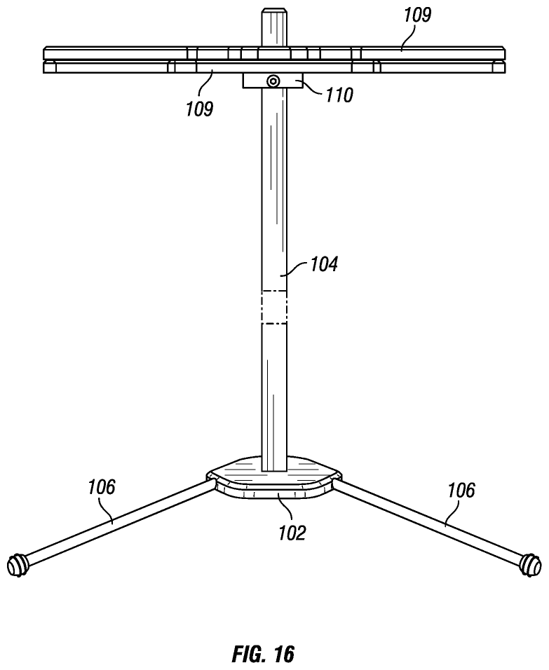

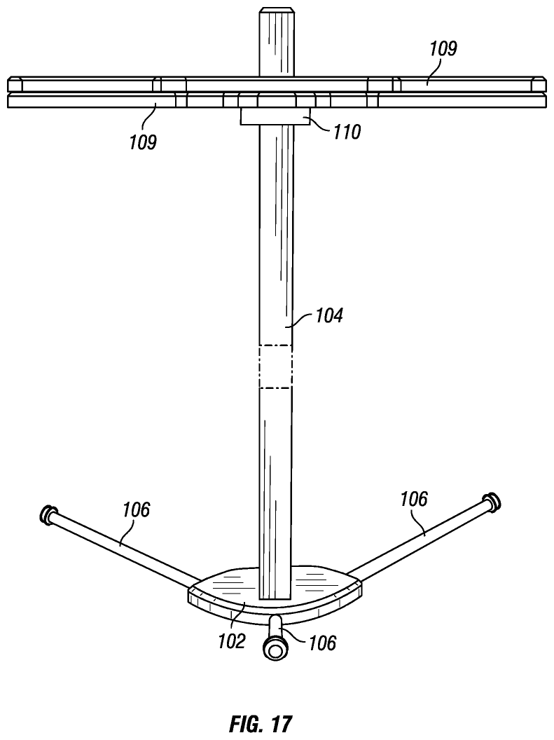

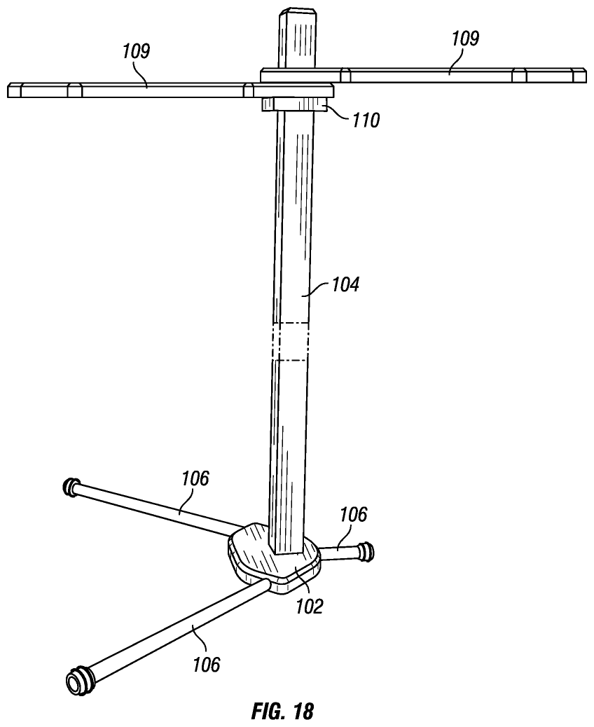

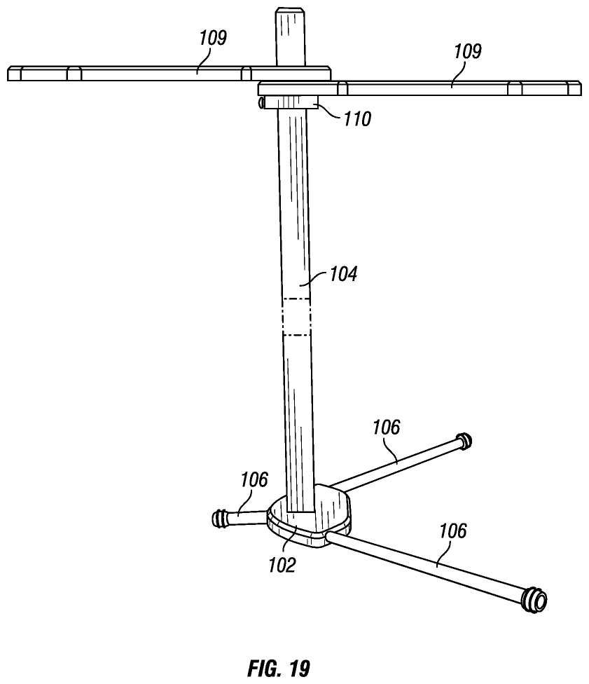

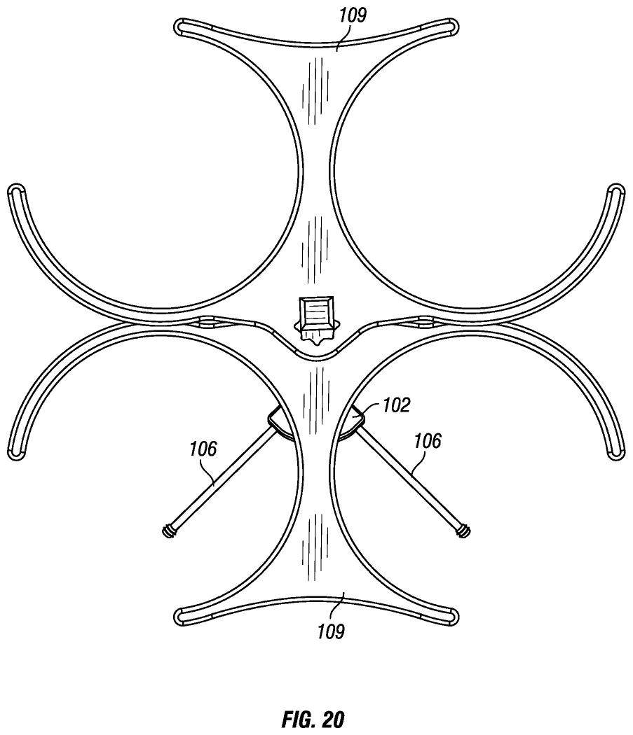

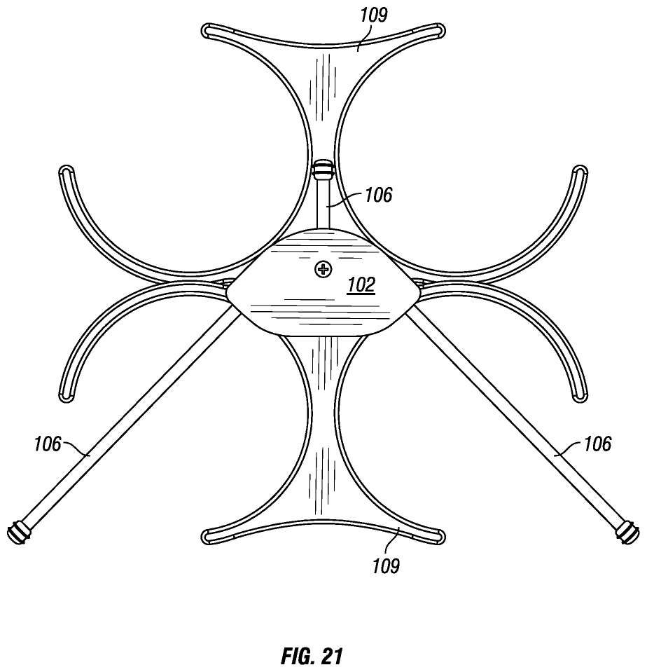

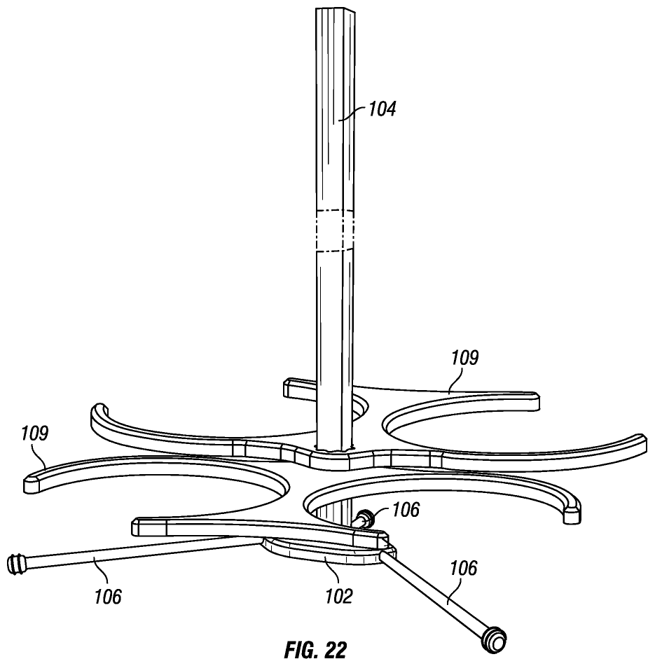

In another embodiment, the shaft 104 may comprise a plurality of protrusions along the length of the shaft. The bowl holders 108 may be configured to move to another position along the shaft 104 by pressing a protrusion inwardly and sliding the bowl holders 108 over the depressed protrusion until the adjustable clasp engages another protrusion. In another embodiment, as shown in FIGS. 15-22, the bowl holder 109 may be configured to hold multiple bowls. In one example, the multiple bowl holder is configured to hold two adjacent bowls 118. In another example, the multiple bowl holder may have an orientation where the bowl holders oppose each other. The dashed-dotted lines on the shaft 104, as depicted in FIGS. 15-22, represent that the shaft 104 may vary in length. In another embodiment, the multiple bowl holder may be configured without a through hole. For example, the bowl holders in the multiple bowl holder may be configured with an inset to place the bowls 118 into. The multiple bowl holder with an inset may be configured in the same orientation as other bowl holders described herein. In another embodiment, the bowl holders 109 may have multiple pieces. For example, the multiple-piece bowl holder may have two semi-circular pieces that are connected to an adjustable clasp 110 via fasteners. Alternatively, the multiple piece bowl holder may comprise a circular piece that is connected to an adjustable clasp 110 via fasteners.

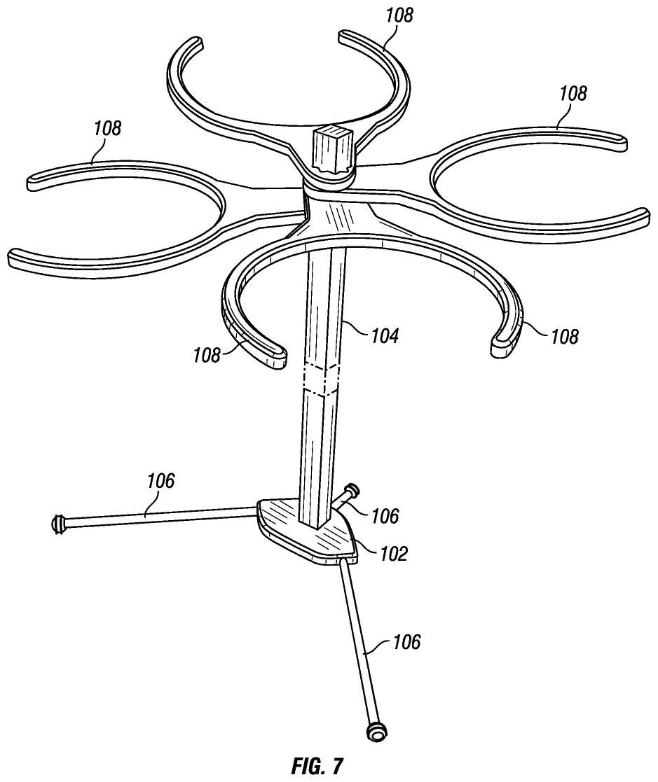

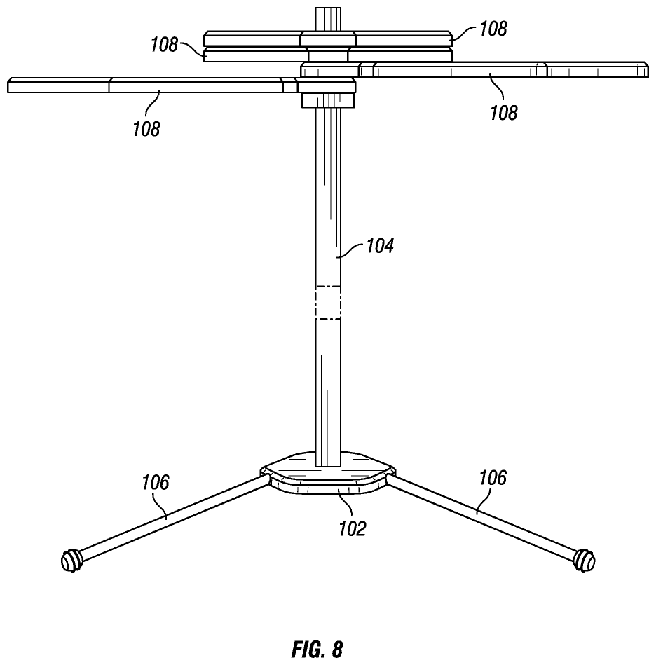

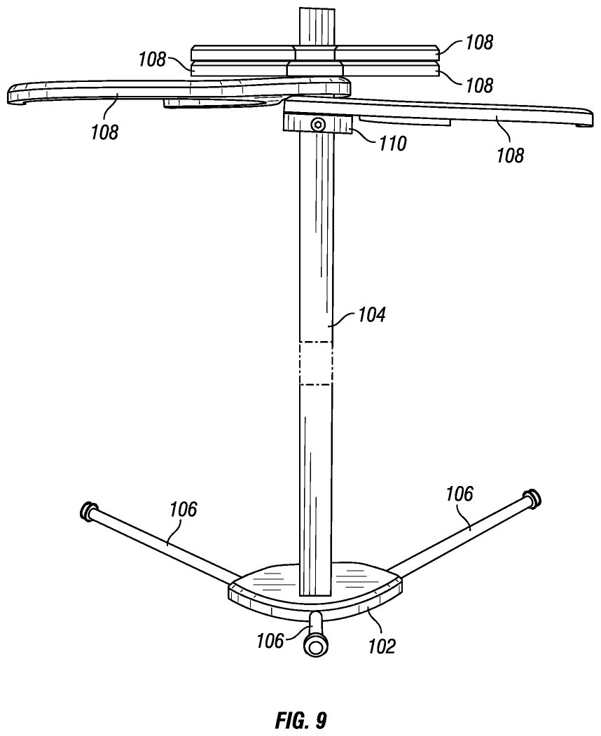

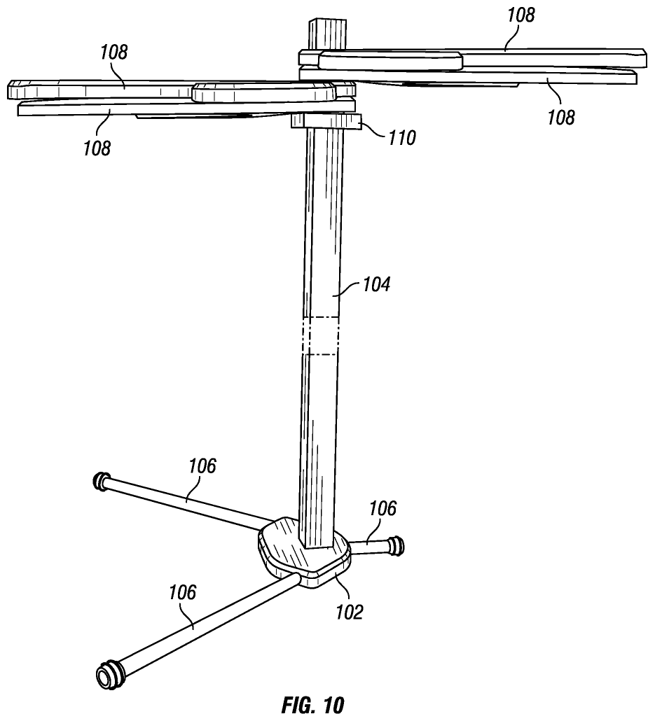

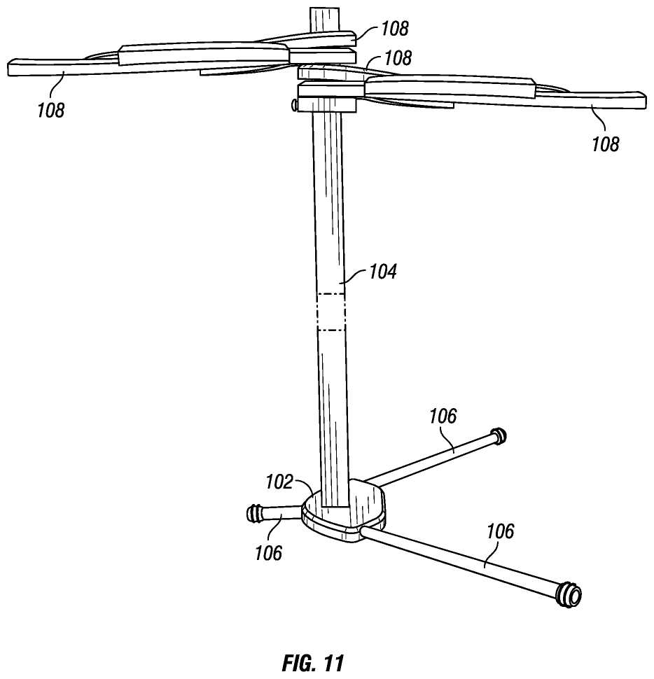

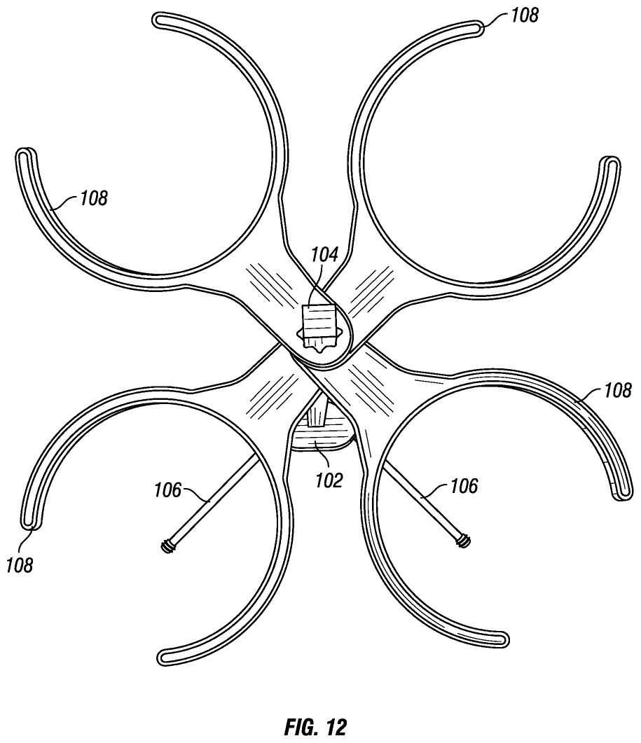

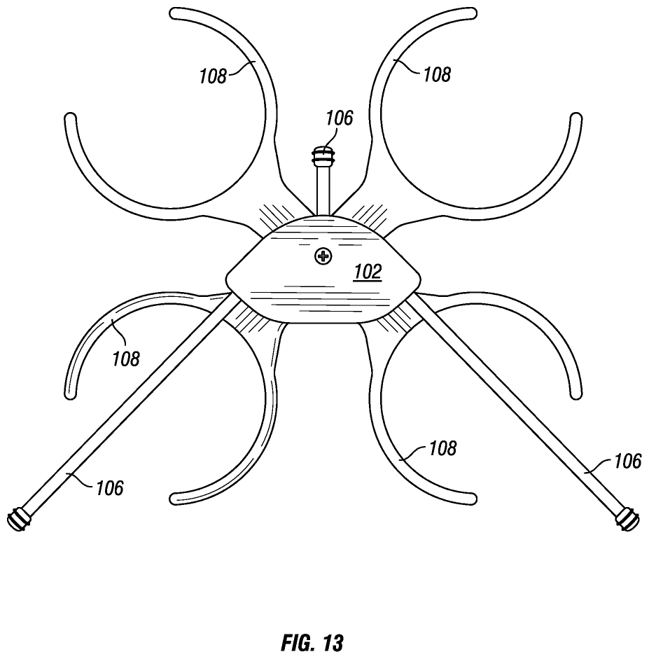

In another embodiment, the adjustable animal bowl stand 100 may comprise a first bowl holder 108 and a second bowl holder 108. The first bowl holder 108 and the second bowl holder 108 may be oriented with the first leg 106 and the second leg 106. In another embodiment, the adjustable animal bowl stand 100 may further comprise a third bowl holder. The first bowl holder 108 may be oriented with the first leg 106, the second bowl holder 108 is oriented with the second leg 106, and the third bowl holder is oriented with the third leg 106. In another embodiment, the adjustable animal bowl stand 100 may further comprise a third bowl holder. The third bowl holder may be oriented with the third leg 106 and the first bowl holder 108 and the second bowl holder 108 are perpendicular to the third bowl holder. In another embodiment, as shown in FIGS. 7-14, the adjustable animal bowl stand 100 may further comprise a third bowl holder and a fourth bowl holder. The third bowl holder positioned to oppose the first bowl holder 108, and the fourth bowl holder positioned to oppose the second bowl holder 108. The dashed-dotted lines on the shaft 104, as depicted in FIGS. 7-14, represent that the shaft 104 may vary in length.

In another embodiment, the adjustable animal bowl stand 100 may further comprise a second adjustable clasp 110 configured to connect slidably around the shaft 104. The second adjustable clasp 110 may comprise an enclosure 124 that forms a perimeter around the second adjustable clasp 110. The second adjustable clasp 110 may further comprise a hole 122 through the second adjustable clasp 110. The hole 122 is dimensioned to fit around the shaft 104. The second adjustable clasp 110 may further include a bore 120 extending through the enclosure 124 to the hole 122. The second adjustable clasp 110 may further include a fastener 112 dimensioned to fit through the bore 120 and engage with the shaft 104. When the fastener 112 engages with the shaft 104, the second adjustable clasp 110 is secured to the shaft 104. In one embodiment, the first adjustable clasp 110 may be positioned at a higher elevation than the second adjustable clasp 110. This configuration enables the plurality of bowl holders 108 to be positioned at varying heights and allow for animals of different sizes to access the bowls.

The adjustable animal bowl stand 100 is also configured to be readily disassembled. The plurality of legs 106 may be removed from the bores in the horizontal base 102. The shaft 104 may be removed from the horizontal base 102. The at least one bowl holder 108 and adjustable clasps 110 may be slidably removed from the shaft 104. Such easy disassembly enables the adjustable animal bowl stand 100 to be readily portable while providing a sturdy structure.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations is encompassed by the disclosure unless otherwise indicated herein or otherwise clearly contradicted by context.

While various embodiments in accordance with the principles disclosed herein have been described above, it should be understood that they have been presented by way of example only and not limitation. Thus, this disclosure's breadth and scope should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure but should not be constrained by the headings set forth herein.

What is claimed is:

1. An adjustable animal bowl stand for holding at least one bowl comprising:
a horizontal base;
a shaft having a first end and a second end, the first end of the shaft attached to the horizontal base, the shaft extending in a vertical direction from the horizontal base;
an adjustable clasp slidably connected around the shaft, the adjustable clasp having a friction locking mechanism; and
at least one bowl holder supported by the adjustable clasp.

2. The adjustable animal bowl stand of claim 1, wherein the shaft is a square, wherein further the at least one bowl holder comprises an octagonal slot, wherein further the at least one bowl holder is configured to be adjusted to eight different positions around the square shaft.

3. The adjustable clasp of claim 2, further comprising:
a hole through the adjustable clasp, the hole dimensioned to fit around the shaft,
a bore extending through a perimeter of the adjustable clasp to the hole,
wherein the friction locking mechanism is configured to fit through the bore and secure the adjustable clasp to the shaft.

4. The adjustable animal bowl stand of claim 1, further comprising a plurality of legs removably secured to the horizontal base, wherein the horizontal base comprises a plurality of bores located around a perimeter of the horizontal base, wherein further the plurality of legs extend radially from the bores of the horizontal base.

5. The adjustable animal bowl stand of claim 4, wherein the plurality of legs consists of a first leg, a second leg, and a third leg.

6. The adjustable animal bowl stand of claim 4, wherein the first leg and the second leg form an angle between 30 degrees and 90 degrees, wherein further the third leg forms and angle greater than 90 degrees from the first leg, wherein further the third leg forms an angle greater than 90 degrees from the second leg.

7. The adjustable animal bowl stand of claim 1, wherein the at least one bowl holder comprises a hole located at a proximal end and a rack located at a distal end, the hole configured to fit around the shaft and rest on top of the adjustable clasp, the rack configured to support the at least one animal bowl, wherein further the at least one bowl holder is configured to be adjusted to different positions around the shaft.

8. The adjustable animal bowl stand of claim 6, further comprising a second bowl holder.

9. The adjustable animal bowl stand of claim 8, further comprising a third bowl holder, wherein the first bowl holder is oriented with the first leg and the second bowl holder is oriented and the second leg, wherein further the third bowl holder is oriented with the third leg.

10. The adjustable animal bowl stand of claim 8, further comprising a third bowl holder and a fourth bowl holder, wherein the third bowl holder opposes the first bowl holder and the fourth bowl holder opposes the second bowl holder.

11. The adjustable animal bowl stand of claim 1, further comprising:
a second adjustable clasp removably coupled to the shaft, and
a second bowl holder supported by the second adjustable clasp, the second bowl holder slidably coupled to the shaft.

12. An adjustable animal bowl stand for holding a plurality animal bowls comprising:
a horizontal base;
a plurality of legs removably secured to the horizontal base, the plurality of legs extending radially from the horizontal base;
a square shaft having a first end and a second end, the first end of the square shaft is attached to the horizontal base, the square shaft extending in a vertical direction from the horizontal base;
an adjustable square clasp slidably connected around the square shaft, the adjustable square clasp having:
a square hole through the adjustable square clasp, the square hole dimensioned to fit around the square shaft,
a bore extending through a perimeter of the adjustable square clasp to the square hole,
a friction locking mechanism configured fit through the bore and secure the adjustable square clasp to the square shaft,
a plurality of bowl holders having an octagonal-shaped hole located at a proximal end and a rack located at a distal end, the plurality of bowl holders configured to rest on top of the adjustable square clasp,
wherein the octagonal-shaped hole is configured to fit around the square shaft,
wherein further the plurality of bowl holders is configured to be adjusted to eight different positions around the square shaft, and
wherein further the rack is configured to support the animal bowl.

13. The adjustable animal bowl stand of claim 12, wherein the adjustable animal bowl stand comprises a first leg, a second leg, and a third leg.

14. The adjustable animal bowl stand of claim 13, wherein the first leg and the second leg have a length between 5 inches and 15 inches, and the third leg has a length between 1 inch and 5 inches.

15. The adjustable animal bowl stand of claim 14, wherein the first leg and the second leg form an angle between 30 degrees and 90 degrees, wherein further the third leg forms and angle greater than 90 degrees from the first leg, wherein further the third leg forms an angle greater than 90 degrees from the second leg.

16. The adjustable animal bowl stand of claim 15, wherein the adjustable animal bowl comprises a first bowl holder and a second bowl holder.

17. The adjustable animal bowl stand of claim 16, further comprising a third bowl holder, wherein the first bowl holder is oriented with the first leg and the second bowl holder is oriented with the second leg, wherein further the third bowl holder is oriented with the third leg.

18. The adjustable animal bowl stand of claim 15, further comprising a third bowl holder, wherein the third bowl holder is oriented with the third leg, and the first bowl holder and the second bowl holder are perpendicular to the third bowl holder.

19. The adjustable animal bowl stand of claim 16, further comprising a third bowl holder and a fourth bowl holder, wherein the third bowl holder opposes the first bowl holder and the fourth bowl holder opposes the second bowl holder.

20. The adjustable animal bowl stand of claim 12, further comprising:
a second adjustable square clasp removably coupled to the shaft, and
a second bowl holder supported by the second adjustable square clasp, wherein the second bowl holder is slidably coupled to the shaft.
